(19) United States
(12) Patent Application Publication
(10) Pub. No.: US 2021/0276341 A1
(43) Pub. Date: Sep. 9, 2021

(54) PORTABLE IMAGE FORMING APPARATUS AND PORTABLE IMAGE FORMING APPARATUS BODY

(71) Applicants: Yohei OSANAI, Tokyo (JP); Masatoshi ISHIDA, Tokyo (JP); Tomoya FUJII, Tokyo (JP); Kunihiko NISHIOKA, Tokyo (JP); Munekazu HIRATA, Tokyo (JP); Masashi OTA, Tokyo (JP)

(72) Inventors: Yohei OSANAI, Tokyo (JP); Masatoshi ISHIDA, Tokyo (JP); Tomoya FUJII, Tokyo (JP); Kunihiko NISHIOKA, Tokyo (JP); Munekazu HIRATA, Tokyo (JP); Masashi OTA, Tokyo (JP)

(73) Assignee: Ricoh Company, Ltd., Ohta-ku, Tokyo (JP)

(21) Appl. No.: 17/261,285

(22) PCT Filed: Sep. 9, 2019
(86) PCT No.: PCT/JP2019/035388

§ 371 Date: Jan. 19, 2021

(30) Foreign Application Priority Data
Sep. 28, 2018 (JP) 2018-185169

(51) Int. Cl. B41J 3/36; B41J 29/02; B41J 2/125

(52) U.S. Cl. CPC B41J 3/36; B41J 2/125; B41J 29/023

(57) ABSTRACT

A portable image forming apparatus includes a recording section, at least one of a position detection device and a recording material detection device, and an accommodation unit. The recording section is configured to record an image on a recording material. The position detection device is configured to detect a position of the portable image forming apparatus. The recording material detection device is configured to detect presence or absence of the recording material. The accommodation unit includes an image formation material accommodation portion. A projection region of the at least one of the position detection device and the recording material detection device with respect to a virtual plane parallel to a recording surface to face the recording material at least partially overlaps with a projection region of the accommodation unit with respect to the virtual plane.

### TECHNICAL FIELD

The present invention relates to a portable image forming apparatus and a portable image forming apparatus body.

### BACKGROUND ART

A portable image forming apparatus is known that includes a recording section to record an image on a recording material, at least one of a position detector to detect a position of the apparatus and a recording material detector to detect presence and absence of the recording material, and an accommodation unit including an image formation material accommodation portion. For example, JP-2001-315385-A discloses a portable image forming apparatus including a position detector (rotation detection sensor), a recording material detector (printing object detection sensor), and an accommodation unit (head cartridge).

### CITATION LIST

### Patent Literature

PTL 1: JP-2001-315385-A

### SUMMARY OF INVENTION

### Technical Problem

In the portable image forming apparatus disclosed in JP-2001-315385-A, the position detector and the recording material detector are disposed on an outer side in a width direction of the accommodation unit. Accordingly, a size in the width direction increases, which leads to an increase in size of an installation space of the portable image forming apparatus.

### Solution to Problem

A portable image forming apparatus includes a recording section, at least one of a position detection device and a recording material detection device, and an accommodation unit. The recording section is configured to record an image on a recording material. The position detection device is configured to detect a position of the portable image forming apparatus. The recording material detection device is configured to detect presence or absence of the recording material. The accommodation unit includes an image formation material accommodation portion. A projection region of the at least one of the position detection device and the recording material detection device with respect to a virtual plane parallel to a recording surface to face the recording material at least partially overlaps with a projection region of the accommodation unit with respect to the virtual plane.

### Advantageous Effects of Invention

According to the invention, a significant effect capable of reducing an installation space of the portable image forming apparatus is exhibited.

### BRIEF DESCRIPTION OF DRAWINGS

FIG. 1 is a view illustrating a cartridge projection region and a sensor projection region.

FIG. 2 is an external perspective view of an HMP when seen from a left obliquely upward side of a rear surface.

FIG. 3 is a bottom view of the HMP.

FIG. 4 is a schematic cross-sectional view of the HMP when seen from a left lateral side.

FIG. 5 is a view illustrating a position relationship between a user's hand and the HMP when operating the HMP.

FIG. 6 is a view illustrating a state in which an image is formed on recording paper by the HMP.

FIG. 7 is a block diagram illustrating a part of an electric circuit of the HMP.

FIG. 8 is an external perspective view of the HMP when seen from a left obliquely upward side of a front surface.

FIG. 9 is an external perspective view of the HMP in which an upper unit is set to an open state.

FIG. 10 is a perspective view of the HMP in a state in which an ink cartridge is popped up.

FIGS. 11A and 11B (FIG. 11) are perspective views of the HMP when seen from an obliquely downward side, FIG. 11A is an external perspective view of the entirety and FIG. 11B is a perspective view of only an ink cartridge and a position detection sensor.

FIG. 12 is a schematic cross-sectional view illustrating a configuration of determining positions in a Y-axis direction and a Z-axis direction in the HMP.

FIG. 13 is an enlarged perspective view of the vicinity of a lower end of the ink cartridge.

FIG. 14 is a cross-sectional view of the vicinity of a lower end of the HMP taken through A-A of FIG. 3.

FIG. 15 is a schematic cross-sectional view of an HMP of Modification Example 1 when seen from a left lateral side.

FIG. 16 is a schematic cross-sectional view illustrating forces acting on an ink cartridge of the HMP illustrated in FIG. 12.

FIGS. 17A to 17C (FIG. 17) are top views of pressure plates, FIG. 17A is a view illustrating a rectangular pressure plate, FIG. 17B is a view illustrating an elliptical pressure plate, and FIG. 17C is a view illustrating an oval-shaped pressure plate.

FIG. 18 is a schematic cross-sectional view of an HMP of Modification Example 2 when seen from a left lateral side.

FIG. 19 is a view illustrating a state in which a pressure plate of the HMP of Modification Example 2 is inclined.

FIG. 20 is a schematic cross-sectional view of the HMP in a state in which the upper unit is closed.

FIG. 21 is a schematic cross-sectional view of the HMP during release of the upper unit.

FIG. 22 is a schematic cross-sectional view of the HMP in a state in which the upper unit is opened.

FIG. 23 is a schematic cross-sectional view of the HMP taken through E-E of FIG. 12.

FIG. 24 is an external perspective view of the ink cartridge when seen from an obliquely downward side.

FIG. 25 is a view illustrating a configuration in which the entirety of the sensor projection region is disposed to be located inside the cartridge projection region.

### DESCRIPTION OF EMBODIMENTS

Hereinafter, description will be given of a first embodiment in which the present invention is applied to a handy mobile printer (hereinafter, referred to as “HMP 1”) that is a portable image forming apparatus. First, a basic configuration of the HMP 1 according to an embodiment will be described.

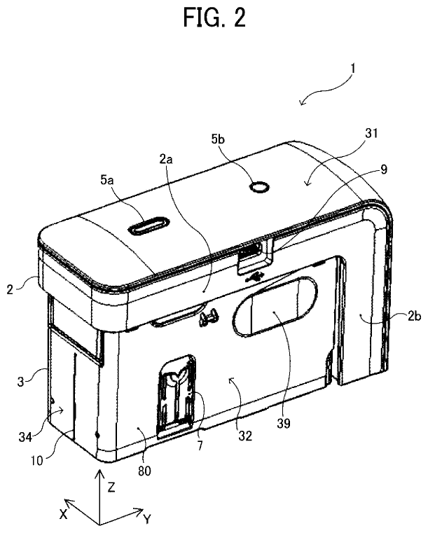

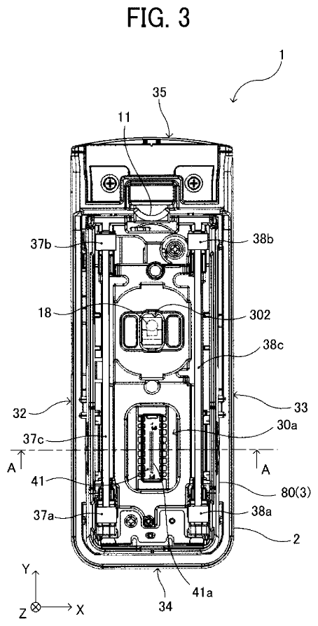

FIG. 2 is an external perspective view of the HMP 1 when seen from a left obliquely upward side of a rear surface. FIG. 3 is a bottom view of the HMP 1. As illustrated in FIG. 2, the HMP 1 mainly includes an upper unit 2 and a lower unit 3. The HMP 1 has an approximately rectangular parallelepiped shape as a whole, and a length of the HMP 1 in a scanning direction (=a print direction: an X-axis direction in the drawing) is set to a certain extent capable of being gripped by a user with a hand.

As illustrated in FIG. 2, a right-left direction (short side direction) of a main body of the HMP 1 is set as the X-axis direction, and a longitudinal direction of the main body which is orthogonal to the X-axis direction is set as a Y-axis direction. In a print operation using the HMP 1, in a case of linearly printing characters, a pattern, or the like, the HMP 1 is moved to the X-axis direction (scanning direction). In addition, the HMP 1 is moved to the Y-axis direction to change a line. However, the print operation using the HMP 1 is not limited to the above-described operation. In a case of disposing characters, a pattern, or the like in consideration of a design, it is possible to perform printing by moving the HMP 1 to an oblique direction other than the X-axis direction or along a curved line. In addition, it is possible to change a line by moving the HMP 1 to a direction other than the Y-axis direction.

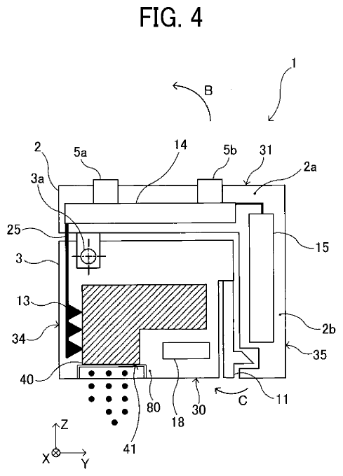

FIG. 4 is a schematic cross-sectional view of the HMP 1 when seen from a left lateral side. As illustrated in FIG. 4, the upper unit 2 has an L-shape including a horizontal extending portion 2a that extends in the Y-axis direction, and a vertical extending portion 2b that extends in a Z-axis direction. As a power supply that supplies electric power to respective devices of the HMP 1, a battery 15 is disposed on an inner side of the vertical extending portion 2b of the upper unit 2. A control board 14 is disposed in the horizontal extending portion 2a, and a print key 5a and a power key 5b are coupled to the control board 14. The power key 5b is a button for switching power ON/OFF of the HMP 1, and the print key 5a is a button for operating an ink discharging timing.

The lower unit 3 includes an upper-unit rotation shaft 3a that rotatably supports the upper unit 2, a position detection sensor 18, a flexible printed circuit (FPC) terminal 13, an upper-unit lock claw 11, a housing 80 that holds the above-described components, and the like. The position detection sensor 18 is an optical sensor (reflection type) that detects position coordinates and presence and absence of a printing object. In addition, an ink tank integral type ink cartridge 40 (inkjet head) that integrally includes a recording section 41 (image forming section) and an ink tank is accommodated inside the housing 80 of the lower unit 3 in a detachable manner with respect to the housing 80. The ink cartridge 40 forms an image by discharging liquid droplets of ink from the recording section 41, and when the ink cartridge 40 is used in a state of being mounted to the HMP 1, the recording section 41 that discharges liquid droplets of ink faces a downward side in a vertical direction.

The upper unit 2 is fitted to the lower unit 3 to freely rotate around the center of the upper-unit rotation shaft 3a. When the upper unit 2 is rotated with respect to the lower unit 3 in an arrow “B” direction in FIG. 4, an upper opening of the housing 80 of the lower unit 3 is exposed, and the ink cartridge 40 disposed inside the housing 80 can be detached.

In the HMP 1 of this embodiment, the battery 15 is disposed in the vertical extending portion 2b of the upper unit 2 located to cover a front side (right side in FIG. 4) of the lower unit 3, and the battery 15 is positioned on a front surface 35 side of the ink cartridge 40. Accordingly, the height of the HMP 1 is set to be lower in comparison to a configuration in which the battery 15 having a heavy weight is located on an upward side of the ink cartridge 40. Accordingly, it is possible to lower the central position of the HMP 1, and it is possible to suppress overturning of the HMP 1 when being moved.

A size (apparatus width) of the HMP 1 in the scanning direction (the X-axis direction) is slightly wider that a width of the ink cartridge 40. When the apparatus width is set to be as small as possible, a range in which the HMP 1 can be moved on the surface of the recording paper P in the scanning direction is broadened, and it is possible to broaden a recordable range on a surface of recording paper P as much as possible.

The HMP 1 includes a recording surface 30 (lower surface) that is an opposing surface from which the recording section 41 of the ink cartridge 40 faces a recording material such as paper. In addition, the HMP 1 includes an upper surface 31 that is opposite to the recording surface 30, and a left lateral surface 32 that extends in a scanning-orthogonal direction (the Y-axis direction in the drawing) that is a direction orthogonal to the scanning direction of the HMP 1. In addition, the HMP 1 also includes a right lateral surface 33 that extends in the scanning-orthogonal direction (the Y-axis direction in the drawing), a rear surface 34 that extends in the scanning direction (the X-axis direction in the drawing), a front surface 35 that extends in the scanning direction, and the like. The HMP 1 is used in a posture in which the recording surface 30 faces a vertically downward direction, and the upper surface 31 faces a vertically upward direction.

The print key 5a and the power key 5b are provided inside an outer edge (in a frame) of the upper surface 31. In addition, a universal serial bus (USB) connection port 9 is provided in the left lateral surface 32 of the upper unit 2. The USB connection port 9 is provided for connection of a USB cable. Electric power is supplied from an external power supply to the charging-type battery 15 mounted in the HMP 1 through a USB cable connected to the USB connection port 9 to charge the battery 15.

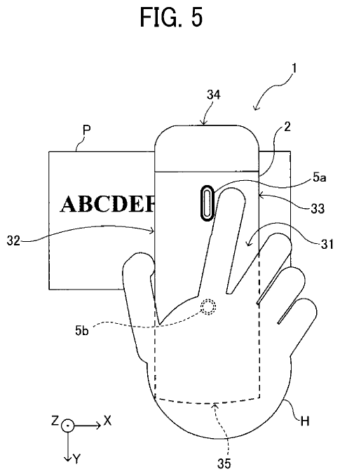

As illustrated in FIG. 2 and FIG. 4, the L-shaped upper unit 2 is disposed to cover the upper surface 31 side and the front surface 35 side of the lower unit 3, and the upper unit 2 has a shape of which a width (a length in the X-axis direction) is wider in comparison to the lower unit 3. FIG. 5 is a view illustrating a position relationship between a hand H of a user and the HMP 1 when the user operates the HMP 1.

As illustrated in FIG. 5, when moving the HMP 1 in the scanning direction (the X-axis direction in the drawing and a right and left direction in FIG. 5) on a surface of the recording paper P to form an image, the user moves the HMP 1 while gripping the upper unit 2. The upper unit 2 has a width greater than a width of the lower unit 3. Accordingly, a shape that is easy to grip with a user's hand is obtained, and the vertical extending portion 2b can be set as an accommodation section of the battery 15. In addition, as illustrated in FIG. 2, recessed grip portions 39 are respectively formed in the left lateral surface 32 and the right lateral surface 33 of the lower unit 3. The grip portions 39 are formed at positions (typically, positions on which the thumb, and the middle finger or the ring finger are respectively placed) on which fingers of the hand H gripping the upper unit 2 are placed when the user grips the HMP 1 for use. When the user places the fingers on the respective grip portions 39 in the left lateral surface 32 and the right lateral surface 33, and grips the HMP 1 with the HMP 1 interposed between the grip portions 39, the user can stably grip the HMP 1.

In the HMP 1, a user can switch power ON/OFF by pressing the power key 5b for a long time. In a state in which the power is turned on, it is possible to cause the control board 14 provided inside the upper unit 2 of the HMP 1 to acquire image information through radio communication with an external device such as a smart phone using Bluetooth (registered trademark) or the like.

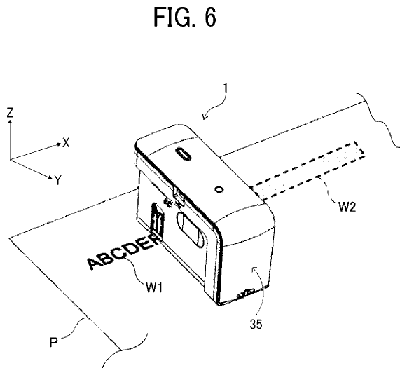

FIG. 6 is a view illustrating a state in which an image is formed on the recording paper P by the HMP 1. After causing the control board 14 to acquire the image information, the HMP 1 is placed on the surface of the recording paper P in a posture in which the recording surface 30 faces a surface of the recording paper P. Then, after pressing the print key 5a once, as illustrated in FIG. 6, the HMP 1 is moved along the scanning direction (the X-axis direction) to form an image on the surface of the recording paper P. As illustrated in FIG. 6, in image formation using the HMP 1, it is possible to perform printing while confirming a printed print portion W1, and a print scheduled portion W2 to be printed.

The HMP 1 can form an image on the surface of the recording paper P when being moved forward to one side (a right direction in FIG. 6) in the scanning direction (the X-axis direction in the drawing), and when being moved backward to the other side (a left direction in the FIG. 6) through a movement operation (manual scanning) by a user. Ink discharging from the ink cartridge 40 may be continuously performed after the print key 5a is pressed once by the user and is detached from the user, or while the print key 5a is being pressed by the user. The recording material is not limited to sheets of paper such as the recording paper P, and examples of the recording material include an overhead projector (OHP), cloth, a cardboard, a packaging container, glass, a substrate, and the like.

As illustrated in FIG. 3, a surface that forms the recording surface 30 of the lower unit 3 (a lower surface of the housing 80) is provided with a discharge opening 30a through which the recording section 41 of the ink cartridge 40 mounted inside the lower unit 3 is exposed to the outside. The recording section 41 of the ink cartridge 40 includes a plurality of discharge slots 41a, and is capable of individually discharging liquid droplets of ink from the discharge slots 41a due to an operation of a piezoelectric element. A width (an image length in a direction (the Y-axis direction) orthogonal to the scanning direction) of an image recording region of the recording section 41 corresponds to a distance between discharge slots 41a located on both ends in the Y-axis direction among the plurality of discharge slots 41a. Ink discharged from the discharge slots 41a of the recording section 41 passes through the discharge opening 30a and reaches the recording paper P, and image formation is performed.

In the ink cartridge 40, as a drive source for discharging ink, an electromechanical conversion element (a piezoelectric actuator or the like) using a lamination-type piezoelectric element, a thin film type piezoelectric element, or the like can be used. In addition, as another configuration of the drive source, an electrothermal conversion element such as a heating resistor, an electrostatic actuator including a vibration plate and a counter electrode, and the like can be used.

As a so-called inkjet mechanism that performs recording by discharging a liquid or liquid droplet such as ink from the ink cartridge 40, a known configuration is applicable. In addition, as the inkjet mechanism, an arbitrary inkjet mechanism can be appropriately employed as long as the inkjet mechanism can be mounted in the HMP 1. In the HMP 1 of this embodiment, the inkjet mechanism corresponds to the recording section 41 that records an image on the recording paper P, and the recording section 41 is accommodated inside the housing 80 of the lower unit 3.

Ink (liquid) discharged from the discharge slots 41a of the recording section 41 may be a liquid having viscosity or surface tension capable of being discharged from the discharge slots 41a and is not limited in particular. However, it is preferable that the viscosity becomes 30 [mPa×s] or less through heating or cooling under ordinary temperature and ordinary pressure. More specifically, examples of the ink (liquid) include a solution, a suspension, an emulsion, and the like which contains a solvent such as water and an organic solvent, a colorant such as a dye and a pigment, a polymerizable compound, a resin, a functionality imparting material such as a surfactant, a biocompatible material such as a deoxyribonucleic acid (DNA), an amino acid, a protein, and calcium, an edible material such as a natural pigment, or the like. For example, these can be used in applications such as inkjet ink, a surface treatment liquid, a liquid for forming a constituent element of an electronic element or a light-emitting element, or an electronic circuit resist pattern, and a material liquid for three-dimensional shaping.

As illustrated in FIG. 3, the position detection sensor 18 as a position detection device that detects a position of the HMP 1 on the recording paper P in a non-contact manner is provided inside an outer edge of the recording surface 30. A detection opening 302 through which a detector of the position detection sensor 18 is exposed is formed in the lower surface of the housing 80 that forms the recording surface 30. In a contact-type sensor using a rotary encoder or the like, a sensor needs to be brought into contact with a print surface, and thus a detection error due to a contact state is likely to occur. Specifically, when the detector of the contact-type sensor is spaced away from the print surface or slides on the print surface, an actual movement direction and an actual movement distance, and a movement direction and a movement distance which are calculated on the basis of a detection result are different, and thus a detection error occurs. In contrast, when the print surface is detected in a non-contact manner by using an optical type sensor as the position detection sensor 18, it is possible to detect the movement direction and the movement distance with high accuracy.

In addition, as illustrated in FIG. 3, a first left roller 37a, a second left roller 37b, a first right roller 38a, and a second right roller 38b which are formed to be rotatable with respect to the housing 80, and the like are provided inside the outer edge of the recording surface 30. The first left roller 37a and the second left roller 37b are secured to a left rotation shaft 37c, and the left rotation shaft 37c is held to be rotatable with respect to the housing 80. Similarly, the first right roller 38a and the second right roller 38b are secured to a right rotation shaft 38c, and the right rotation shaft 38c is held to be rotatable with respect to the housing 80.

When the HMP 1 is moved in the scanning direction by a user, the four rollers (37a, 37b, 38a, and 38b) which are in contact with the surface of the recording paper P rotate like a tire. When the rollers are provided, the user can make the HMP 1 go straight along the scanning direction of the HMP 1. In addition, when making the HMP 1 go straight in the scanning direction, the four rollers (37a, 37b, 38a, and 38b) provided in the HMP 1 come into contact with a surface of the recording paper P or a surface of a stage on which the recording paper P is placed, and the recording surface 30 is not brought into contact with the surface of the recording paper P. Accordingly, the user can make the HMP 1 go straight along the scanning direction while constantly maintaining a distance between the recording section 41 of the ink cartridge 40 and the surface of the recording paper P, and thus it is possible to form a desired image with high image quality. That is, the four rollers function as a movement assist device that guides movement of the HMP 1 in the scanning direction, and assists straight movement in the scanning direction.

The position detection sensor 18 is a sensor that detects a distance up to the surface of the recording paper P or a surface state (for example, unevenness), or detects a movement distance of the HMP 1. For example, a sensor that is used in an optical type mouse (pointing device) of a personal computer, or the like may be used. The position detection sensor 18 irradiates a location (recording paper P) on which the position detection sensor 18 is placed with light, and reads a state of the portion as a “pattern”. In addition, the position detection sensor 18 continuously detects how the “pattern” moves with respect to movement of the position detection sensor 18 to calculate a movement amount. As the position detection sensor 18, an arbitrary sensor may be used as long as the sensor can detect a variation of a position with respect to the recording paper P in a non-contact manner, and sensors such as an ultrasonic sensor other than the optical sensor may be used. In addition, the position detection device provided in a portable image forming apparatus such as the HMP 1 to which the invention is applicable is not limited to the non-contact type sensor such as the position detection sensor 18, and may be a contact-type sensor using a rotary encoder or the like.

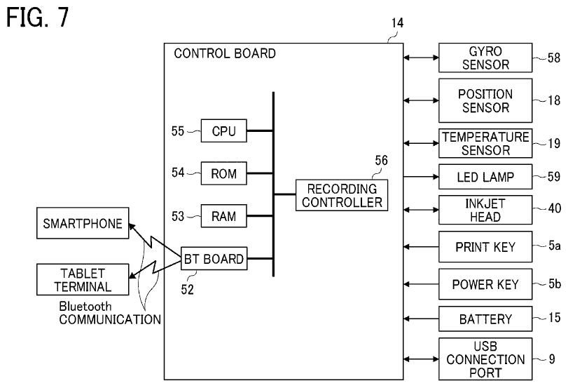

FIG. 7 is a block diagram illustrating a part of an electric circuit of the HMP 1. The control board 14 includes a central process unit (CPU) 55 that performs various kinds of operation processing or program execution, a Bt board 52 for near field radio communication using Bluetooth (registered trademark), a random access memory (RAM) 53 that temporarily stores data, a read-only memory (ROM) 54, a recording controller 56, and the like. The control board 14 is secured to a position inside the USB connection port 9 in a hollow of the upper unit 2.

The Bt board 52 performs data communication by near field radio communication with an external device such as a smart phone and a tablet terminal. In addition, the ROM 54 stores firmware that performs hardware control of the HMP 1, drive waveform data of the ink cartridge 40, and the like. In addition, the recording controller 56 executes data processing for driving the ink cartridge 40, or generates a drive waveform.

A gyro sensor 58, the position detection sensor 18, a temperature sensor 19, a light emitting diode (LED) lamp 59, the ink cartridge 40, the print key 5a, the power key 5b, the battery 15, and the like are electrically coupled to the control board 14. The gyro sensor 58 detects an inclination or a rotation angle of the HMP 1 by a known technology, and transmits the result to the control board 14. The LED lamp 59 is provided inside an exterior package cover formed from a light transmissive material in the print key 5a, and causes the print key 5a to emit light.

When the power key 5b is pressed to turn on the power of the HMP 1, electric power is supplied to respective modules, and the CPU 55 initiates an activation operation on the basis of a program stored in the ROM 54, and develops the program or each piece of data to the RAM 53. When receiving image data of an image to be formed from an external device through near field radio communication, the recording controller 56 generates a drive waveform corresponding to the received image data. In addition, the recording controller 56 controls discharge of ink from the ink cartridge 40 so that an image corresponding to a position, which is detected by the position detection sensor 18, on a surface of the recording paper P is formed.

A movement direction, a movement speed, and a movement distance of the HMP 1 are detected by the position detection sensor 18, and a discharge amount and a discharge position of ink are adjusted on the basis of the detection result to print a target image. In addition, a discharge initiation position can be adjusted by using a sub-scanning guide 7 provided on the left lateral surface 32 and the right lateral surface 33 of the housing 80, and a main scanning guide 10 provided on the rear surface 34 of the housing 80. Particularly, the discharge initiation position can be adjusted by aligning a position of the HMP 1 with respect to the recording paper P in a main scanning direction (the X-axis direction in the drawing) by using the main scanning guide 10, and by aligning a position of the HMP 1 with respect to the recording paper P in a sub-scanning direction (the Y-axis direction in the drawing) by using the sub-scanning guide 7.

In addition, when acquiring the image data through near field radio communication with an external device, the control board 14 flickers the LED lamp 59 to cause the light transmissive print key 5a to emit light and flicker. A user who sees the flickering can understand that the HMP 1 terminates acquisition of the image data, and places the HMP 1 on the recording paper P and presses the print key 5a.

On the other hand, when flickering control of the LED lamp 59 is initiated, the control board 14 waits pressing of the print key 5a. In addition, when the print key 5a is pressed, the control board 14 continuously turns on the LED lamp 59 to cause the print key 5a to continuously emit light. A user who sees the continuous light-emission initiates a movement operation (manual scanning) in the scanning direction of the HMP 1.

The user who terminates the movement operation (manual scanning) of the HMP 1 presses the print key 5a again. According to this, the control board 14 turns off the LED lamp 59 to stop light-emission of the print key 5a. In addition, the HMP 1 may be lifted from the recording paper P without pressing the print key 5a and may be placed on a table or the like as is or may be mounted to a cover member that covers the recording surface 30. In this case, the position detection sensor 18 cannot detect a position when the HMP 1 is lifted from the recording paper P. The control board 14 turns off the LED lamp 59 at timing at which the position detection sensor 18 does not detect the position to stop light-emission of the print key 5a. A user who sees the stoppage of light-emission can understand that a process for print of the HMP 1 is terminated.

In the HMP 1 of this embodiment, the user may not continuously press the print key 5a during the movement operation (manual scanning). When the print key 5a is pressed and is detached from the user before the movement operation, the process for print continues up to a predetermined timing. Examples of the predetermined timing include timing at which image formation based on the detection result of the position detection sensor 18 is terminated, timing at which the print key 5a is pressed again, and timing at which position detection by the position detection sensor 18 is difficult.

When image formation is not performed after termination of image formation, or the like, a capping unit that is a cover member covering the recording surface 30 of the HMP 1 is mounted to the HMP 1. According to this, it is possible to prevent ink in the discharge slot 41a from being dried.

Next, description will be given of a shape of the upper unit 2 of the HMP 1 of this embodiment. The HMP 1 includes the lower unit 3 and the upper unit 2. The lower unit 3 is an apparatus body including the recording section 41. The upper unit 2 is a cover member that opens or closes a recording section opposite surface (an upper opening of the housing 80) on a side opposite to a recording section disposition surface (the lower surface of the housing 80) on which the recording section 41 is disposed in the lower unit 3.

As illustrated in FIG. 2 and FIG. 4, the upper unit 2 has an L-shape including the horizontal extending portion 2a and the vertical extending portion 2b. The horizontal extending portion 2a covers an upper side of the housing 80 which is opposite to the lower surface of the housing 80 on which the recording section 41 is disposed in the lower unit 3. In addition, the vertical extending portion 2b extends from the horizontal extending portion 2a to the recording section disposition surface side (downward side), and covers at least a part of lateral surfaces (the left lateral surface 32, the right lateral surface 33, the rear surface 34, and the front surface 35) between a lower surface and an upper surface in the lower unit 3.

In the HMP 1 of this embodiment, the upper unit 2 that is a cover member has an L-shape, and includes the vertical extending portion 2b that extends from the horizontal extending portion 2a to the recording surface side (downward side). The vertical extending portion 2b is provided, and thus not only the horizontal extending portion 2a but also the vertical extending portion 2b can be used as a site that provides an opening or closing force when being in contact with a hand during an opening or closing operation. Accordingly, it is possible to perform the opening or closing operation in a state of gripping at least one side that is easy to provide the opening or closing force between the horizontal extending portion 2a on a side opposite to the recording surface 30 in the HMP 1, and the vertical extending portion 2b on a lateral side of the recording surface 30, and it is possible to improve operability of the opening or closing operation of the upper unit 2.

As illustrated in FIG. 4, in the HMP 1 of this embodiment, the battery 15 is disposed in the vertical extending portion 2b that is a portion that extends in an upper and lower direction of the HMP 1 in the L-shape of the upper unit 2. According to this, the battery 15 having a relatively heavy weight can be disposed on a lateral side of the lower unit 3 instead of an upper side of the lower unit 3. In addition, a longitudinal direction of the battery 15 having a relatively heavy weight can be disposed in a height direction of the HMP 1. Accordingly, it is possible to lower the center of gravity of the entirety of the apparatus, and thus the HMP 1 is less likely to overturn. As a result, a configuration of improving operability of a user is implemented. In this manner, the operability of the user is improved, and thus it is possible to prevent deterioration of a printed image due to deterioration of operability of the HMP 1.

It is preferable that a position of a head (print position) in an X-Y plane parallel to the surface of the recording paper P is disposed on the rear surface 34 side in the longitudinal direction of the HMP 1 (the Y-axis direction) from the viewpoint of operability of the user. The reason for this is as follows. When the print position is disposed on the rear surface 34 side in the longitudinal direction of the HMP 1, it is possible to make a margin of an upper side a printed matter small when performing printing in such a manner that a lower side of the printed matter is located in front of the user. Typically, the printed matter is written on the top, and thus it is preferable to make the margin on the upper side of the printed matter smaller in comparison to the lower side of the printed matter. According to this, it is preferable that the position of the head (print position) is located on the rear surface 34 side in the longitudinal direction of the HMP 1.

It is preferable that the portable image forming apparatus is provided with a lock mechanism (the upper-unit lock claw 11 of this embodiment) that secures the cover member to the apparatus body so that the cover member is not opened or closed during an operation of performing image formation. However, when the cover member is disposed on an upper side of the apparatus body, an operation portion of the lock mechanism is disposed on lateral surfaces (a right lateral surface, a left lateral surface, a front surface, and a rear surface) or an upper surface of the apparatus body. In this structure, in a state in which the apparatus is placed on a paper surface, a user can come into contact with the operation portion of the lock mechanism, and thus there is a concern that the user may erroneously operate the lock mechanism during an image formation operation and thus the cover member may be released.

In the HMP 1 of this embodiment, a lower end of the vertical extending portion 2b forms a part of the recording surface 30 of the HMP 1, and thus a position of the lower end of the vertical extending portion 2b in a direction (downward side) facing the recording surface 30 side from the upper surface 31 side is set to the same position as in the lower surface of the housing 80. The discharge opening 30a is provided in the lower surface of the housing 80, and the upper-unit lock claw 11 that is a lock mechanism is disposed on the recording surface 30 that is a surface in which the discharge opening 30a is provided in the HMP 1. The upper-unit lock claw 11 is an operation portion that is operated to release securing of the upper unit 2 with respect to the lower unit 3.

The recording surface 30 in which the discharge opening 30a is provided is a lower surface of the HMP 1, and in a state in which the HMP 1 is placed on the recording paper P, the recording surface 30 faces the paper surface, and thus it is possible to prevent a user from coming into contact with the upper-unit lock claw 11 disposed on the recording surface 30. According to this, it is possible to prevent the user from erroneously operating the upper-unit lock claw 11 during an image formation operation (print operation), and thus it is possible to prevent the upper unit 2 from being released due to the erroneous operation.

In addition, when the upper-unit lock claw 11 is disposed on the lower surface of the HMP 1, it is possible to prevent the user from coming into contact with the upper-unit lock claw 11 at an unintended timing such as when the user has nothing to do without limitation to the print operation. According to this, it is possible to reduce a possibility of occurrence of a failure in which the upper unit 2 is released at timing that is not intended by the user.

With regard to the configuration capable of preventing the user from erroneously operating the lock mechanism during the image formation operation, there is no limitation to the configuration in which the lower end of the vertical extending portion 2b is set to the same position as in the lower surface of the housing 80. In a shape including the vertical extending portion 2b, when the lock mechanism is disposed on a lower surface that becomes a lower end of the vertical extending portion 2b, or a lateral surface of the housing 80 which is adjacent to the lower surface, it is possible to prevent the user from coming into contact with the lock mechanism due to the vertical extending portion 2b. Contact with the lock mechanism is prevented, and thus it is possible to prevent the user from erroneously operating the lock mechanism during the image formation operation.

The HMP 1 of this embodiment includes a grip portion 39 in each of the left lateral surface 32 and the right lateral surface 33. It is preferable that the grip portion 39 is disposed at the center-of-gravity position in a Y-Z plane of the HMP 1. Particularly, the grip portion 39 is disposed so that the center of gravity in the Y-Z plane of the HMP 1 is located on an inner side of the grip portion 39 in the Y-Z plane. When the grip portion 39 on which a finger is placed when the user grips the HMP 1 is provided at the center-of-gravity position of the HMP 1, it is possible to allow the user to perform an operation in a state of gripping the vicinity of the center of gravity of the HMP 1, and thus a smooth operation by the user is implemented.

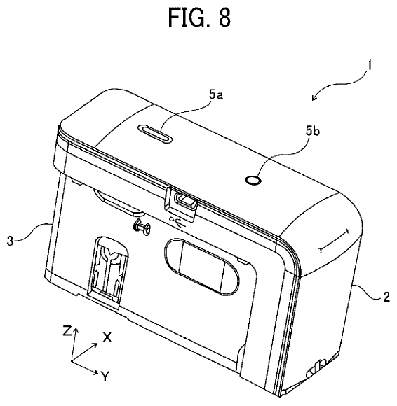

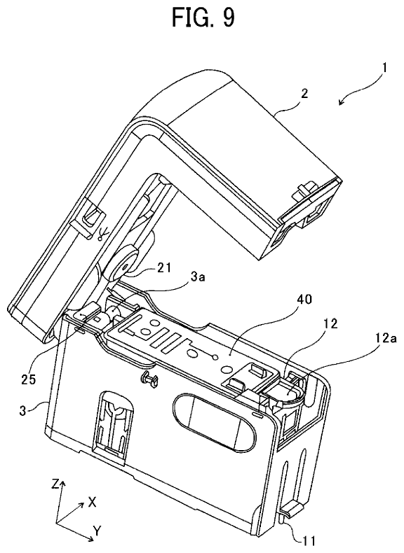

Next, description will be given of an extraction operation of the ink cartridge 40 of the HMP 1 of this embodiment. FIG. 8 is an external perspective view of the HMP 1 when seen from a left obliquely upward side of the front surface, and FIG. 9 is a perspective view of the HMP 1 in a state in which the upper unit 2 is rotated with respect to the lower unit 3 in an arrow “B” direction in FIG. 4 from the state illustrated in FIG. 8. As illustrated in FIG. 3 and FIG. 4, the upper-unit lock claw 11 is disposed in the vicinity of a boundary between the lower unit 3 (the lower surface of the housing 80) and the upper unit 2 (the lower surface of the vertical extending portion 2b) in the recording surface 30 of the HMP 1. When performing an operation of moving the upper-unit lock claw 11 in an arrow “C” direction in FIG. 4, securing of the upper unit 2 with respect to the lower unit 3 is released. In a state in which securing is released, when the upper unit 2 is rotated with respect to the lower unit 3 around the upper-unit rotation shaft 3a in the arrow “B” direction in FIG. 4, as illustrated in FIG. 9, it enters a state in which the upper unit 2 is opened with respect to the lower unit 3.

As illustrated in FIG. 9, when the upper unit 2 is set to an opened state, the ink cartridge 40 and a cartridge attachment and detachment mechanism 12 are exposed. In addition, as illustrated in FIG. 9, a cartridge pressing member 21 that presses and locks the ink cartridge 40 mounted inside the lower unit 3 is secured to an inner surface of the upper unit 2.

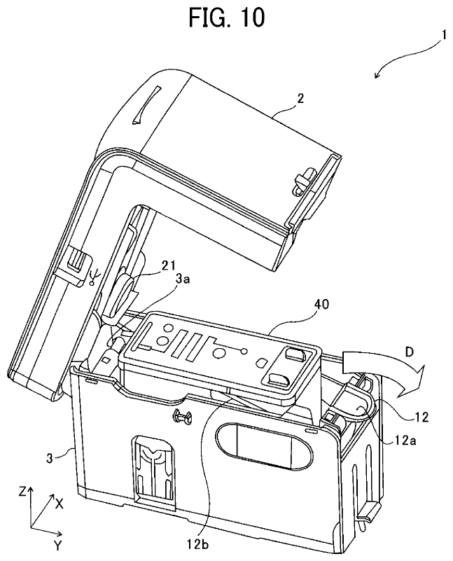

FIG. 10 is a perspective view of the HMP 1 in a state in which an attachment and detachment operating portion 12a of the cartridge attachment and detachment mechanism 12 of the HMP 1 in a state illustrated in FIG. 9 is operated to pop up the ink cartridge 40. When the attachment and detachment operating portion 12a of the cartridge attachment and detachment mechanism 12 is extracted to the front surface side as indicated by an arrow “D” in FIG. 10, the ink cartridge 40 is popped up to an upward side from the state illustrated in FIG. 9, and enters a state illustrated in FIG. 10. According to this, it enters a state in which the ink cartridge 40 can be extracted.

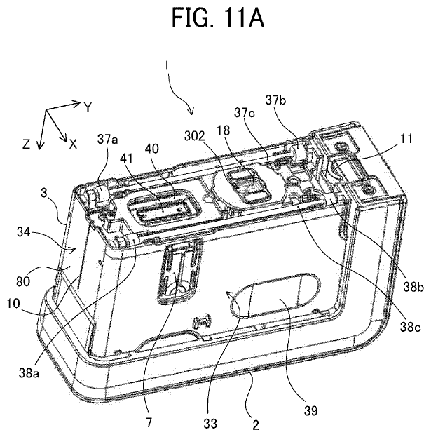

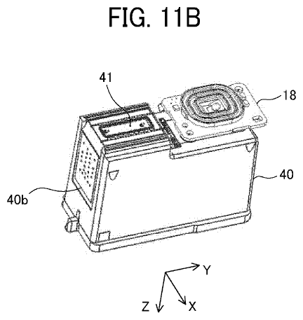

Next, description will be given of a position relationship between the ink cartridge 40 and the position detection sensor 18 in the HMP 1. FIGS. 11A and 11B are perspective views of the HMP 1 when seen from an obliquely downward side. FIG. 11A is an external perspective view of the entirety of the HMP 1 that also includes structure bodies of the upper unit 2 and the lower unit 3. FIG. 11B is a perspective view illustrating a state in which the structure bodies of the upper unit 2 and the lower unit 3 are excluded from the external perspective view illustrated in FIG. 11A and only the ink cartridge 40 and the position detection sensor 18 are displayed.

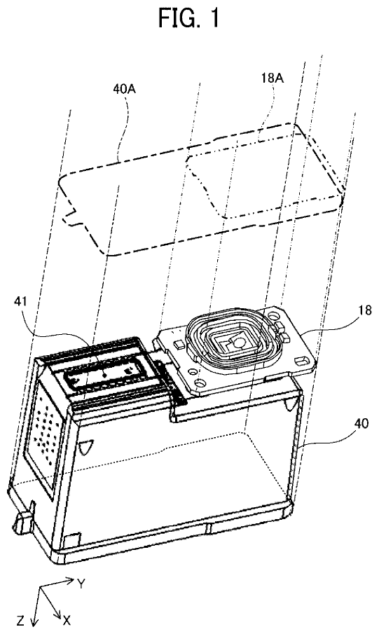

FIG. 1 is a view illustrating a cartridge projection region 40A and a sensor projection region 18A which are obtained by projecting the ink cartridge 40 and the position detection sensor 18 illustrated in FIG. 11B to an arbitrary X-Y plane that is a virtual plane parallel to the recording surface 30 with projection lines parallel to the Z-axis.

The HMP 1 of this embodiment includes the recording section 41 that records an image on the recording paper P that is a recording material, the position detection sensor 18, and the ink cartridge 40 that is an accommodation unit including an ink tank as an image formation material accommodation portion. The position detection sensor 18 has a function as a position detection device that detects a position of an apparatus, and a function as a recording material detection device that detects presence and absence of the recording paper P. In addition, in the HMP 1, as illustrated in FIG. 1, the sensor projection region 18A and the cartridge projection region 40A at least partially overlap each other.

As the portable image forming apparatus such as the HMP 1, a manual scanning type printer for printing on a book or a notebook that is difficult to be printed with an inkjet printer of the related art is known already.

In a portable image forming apparatus described in JP-2001-315385-A, a head cartridge in which an ink tank and a head section are integrally provided is mounted on a main body section. In the portable image forming apparatus, in a case where a line head does not face a print object, printing is not performed. Accordingly, a print object detection sensor that detects presence of the print object in a print region facing the line head is provided. In addition, only when the print object detection sensor detects the print object, the line head is driven.

In the portable image forming apparatus described in JP-2001-315385-A, a rotation detection sensor and the print object detection sensor are disposed in the same planar shape as in an ink discharge device of the head cartridge. In addition, projection regions of the rotation detection sensor and the print object detection sensor projected by projection lines orthogonal to a paper surface are located on an outer side of a projection region of the head cartridge to avoid an installation space of the head cartridge. In this configuration, the size of the entirety of the portable image forming apparatus increases in a direction parallel to the paper surface, and an occupation space (installation space) of the portable image forming apparatus increases.

On the other hand, in the HMP 1 of this embodiment, the sensor projection region 18A and the cartridge projection region 40A at least partially overlap each other. According to this, it is possible to make the size of the HMP 1 small in a direction parallel to the X-Y plane, and it is possible to make occupation area (installation space) of the HMP 1 small.

As illustrated in FIG. 1, in the ink cartridge 40, an upper side is wider than a lower side in which the recording section 41 is provided (a size in the X-axis direction is large), and a region obtained by projecting the wide portion becomes the cartridge projection region 40A. In addition, the recording section 41 is disposed to be located inside the cartridge projection region 40A.

In addition, as illustrated in FIG. 1, the sensor projection region 18A is located inside the cartridge projection region 40A in the X-axis direction with respect to the X-axis direction (width direction) that is one direction in the X-Y plane. That is, a range in which the position detection sensor 18 is located in the X-axis direction is set to an inner side of a range in which the ink cartridge 40 is located in the X-axis direction. According to this, with regard to the width direction of the HMP 1, a configuration in which a protruding portion of the position detection sensor 18 does not exist on an outer side in the width direction of the ink cartridge 40 is implemented. According to this, as described above, it is possible to set the size (apparatus width) of the HMP 1 in the scanning direction (the X-axis direction) to a certain extent that is slightly wider than the width of the ink cartridge 40. When the apparatus width is set to be as small as possible, a range capable of moving the HMP 1 on the surface of the recording paper P in the scanning direction broadens, and thus it is possible to broaden a recording possible range on the surface of the recording paper P as much as possible.

In addition, as illustrated in FIG. 1 and FIG. 4, the ink cartridge 40 has an L-shape in which a part of a rectangular is cut out when the ink cartridge 40 is seen from a lateral direction (direction parallel to the X-axis). In addition, the position detection sensor 18 is disposed in a space which is the cut-out portion and in which two directions including the upper surface 31 side and the rear surface 34 side are surrounded by the ink cartridge 40. That is, the position detection sensor 18 is disposed in a dead space between a lower inner wall of the housing 80 that is a casing of the apparatus body and a lower outer wall of the ink cartridge 40 due to the characteristic shape (L-shape) of the ink cartridge 40. According to this, a configuration in which a protruding portion of the position detection sensor 18 does not exist on an upward side or a downward side in comparison to the ink cartridge 40 is realized, and it is possible to implement a reduction in size in an upper and lower direction of the HMP 1 that accommodates the ink cartridge 40.

In addition, in a case of using a rectangular parallelepiped member of which a lateral surface shape is a rectangle as the ink cartridge 40, when the position detection sensor 18 is disposed below the rectangular parallelepiped, the recording section 41 provided on a lower surface of the rectangular parallelepiped is spaced away from the surface of the recording paper P, and print performance deteriorates. In contrast, when the lateral surface shape of the ink cartridge 40 is set to the L-shape, it is possible to make the recording section 41 close to the surface of the recording paper P while securing a space for disposing the position detection sensor 18 below the ink cartridge 40, and thus it is possible to improve print performance.

In addition, as described above, in the HMP 1 of this embodiment, the position detection sensor 18 has a function of a position detection device that detects a position of the apparatus, and a function of a recording material detection device that detects presence or absence of the recording paper P. According to this, it is possible to simultaneously perform position detection of the apparatus body of the HMP 1, and detection of presence or absence of the recording paper P that is a print object by one sensor. Accordingly, the number of parts is reduced, and a reduction in size of the HMP 1 is realized.

As the position detection sensor 18, a reflection type optical sensor including a light-emitting unit and a light-receiving unit is used. As the optical sensor, a Red LED type, a Blue LED type, a laser type, an infrared (IR) LED type, or the like can be used. As a reflection type sensor, it is possible to employ a configuration which emits a sound wave such as an ultrasonic wave or a radio wave and receives a reflected wave to detect a position of the apparatus or presence or absence of a recording material without limitation to the optical sensor. However, when using the reflection type optical sensor that is typically used, it is possible to realize a reduction in size and the cost of the apparatus.

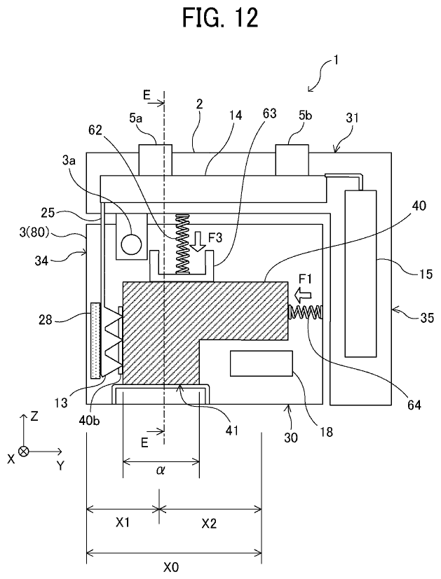

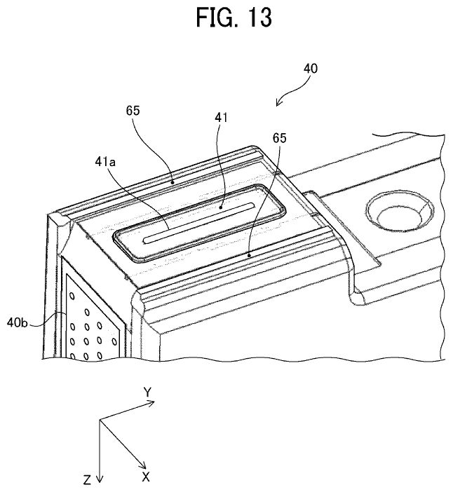

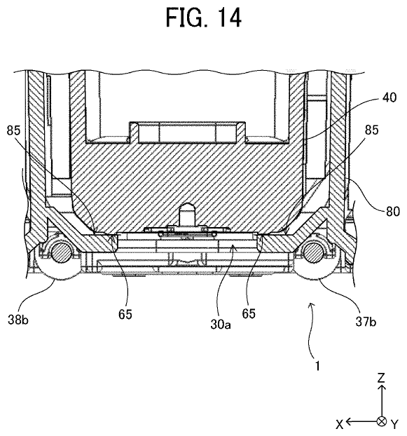

FIG. 12 is a schematic cross-sectional view of the HMP 1 when seen from a left lateral side, and illustrates a configuration of determining positions in the Y-axis direction and the Z-axis direction of the ink cartridge 40 with respect to the main body of the HMP 1. FIG. 13 is an enlarged perspective view of the vicinity of a lower end of the ink cartridge 40, and FIG. 14 is a cross-sectional view of the vicinity of the lower end of the HMP 1 taken through A-A of FIG. 3. As illustrated in FIG. 12 and FIG. 13, a cartridge terminal 40b is disposed on an outer wall surface on the rear surface side of the ink cartridge 40.

When the ink cartridge 40 is mounted in the lower unit 3, and the FPC terminal 13 and the cartridge terminal 40b come into contact with each other, the FPC terminal 13 and the cartridge terminal 40b are electrically coupled to each other. According to this, drive power is supplied from the power supply (battery) 15 to the ink cartridge 40, and the control board 14 is coupled to the ink cartridge 40. Accordingly, an electric signal for controlling the ink cartridge 40 is transmitted to the ink cartridge 40.

As illustrated in FIG. 12, a flexible flat cable 25 is disposed on the rear surface 34 side of the upper-unit rotation shaft 3a, and thus the control board 14 inside the upper unit 2 and the FPC terminal 13 inside the lower unit 3 are coupled to each other. The flexible flat cable 25 can be deformed in conformity to an opening or closing operation of the upper unit 2, and even when the opening and closing operation of the upper unit 2 is repeated, the coupling state between the control board 14 and the FPC terminal 13 can be maintained.

In addition, as illustrated in FIG. 12, an elastic member 28 that is formed from a silicone rubber or the like and has a relatively small deformation amount is disposed on the rear surface 34 side of the FPC terminal 13. When mounting the ink cartridge 40, due to the elastic member 28, it is possible to secure a position of the FPC terminal 13 after mounting the ink cartridge 40 while allowing the FPC terminal 13 pushed out by the cartridge terminal 40b to move the rear surface 34 side.

As illustrated in FIG. 13, the lower end of the ink cartridge 40 in which the recording section 41 is disposed is provided with an upper and lower direction positioning portion 65 as a “vertical direction positioning portion” that abuts against the housing 80 and determines an upper and lower direction position of the ink cartridge 40 with respect to the lower unit 3. The upper and lower direction positioning portion 65 is disposed at two sites in the width direction, and the two upper and lower direction positioning portions 65 are disposed with the recording section 41 interposed between the two upper and lower direction positioning portions in a width direction.

The ink cartridge 40 is pressed by an upper and lower spring 62 that is a “vertical direction biasing device” and a front and back spring 64 that is a “horizontal direction biasing device”. As indicated by an arrow “F3” in FIG. 12, a downward force increases by the upper and lower spring 62, and as indicated by an arrow “F1” in FIG. 12, a force in a direction facing the rear surface 34 side increases by the front and back spring 64. The upper and lower spring 62 is locked to the upper unit 2, and the front and back spring 64 is locked to the housing 80 of the lower unit 3.

As illustrated in FIG. 12, the upper and lower spring 62 presses the ink cartridge 40 to a downward direction through a pressure plate 63, and as illustrated in FIG. 14, the upper and lower direction positioning portion 65 of the ink cartridge 40 abuts against an opening edge inner wall surface 85 of the housing 80. According to this, the upper and lower direction (Z-axis direction) position of the ink cartridge 40 with respect to the apparatus body of the HMP 1 is determined. In addition, as illustrated in FIG. 13, the upper and lower direction positioning portion 65 of the ink cartridge 40 is disposed in the vicinity of the discharge slots 41a of the recording section 41. According to this, it is possible to provide the upper and lower direction positioning portion 65 with respect to the discharge slots 41a with high accuracy, and it is possible to position the ink cartridge 40 including the recording section 41 with respect to the surface of the recording paper P that is a print object with high accuracy. The upper and lower spring 62 and the pressure plate 63 in FIG. 12 are included in the cartridge pressing member 21 illustrated in FIG. 9 and FIG. 10.

Typically, it is preferable that the discharge slots 41a are located at a distance of approximately “1.5±0.2 [mm]” from a print object. The reason for this is as follows. Specifically, an influence on a shape or a position of ink drops, a mist, or the like occurs in accordance with a distance between the discharge slots 41a and the print object, and a desired appropriate amount of ink drops may not land at a desired position. That is, when the distance between the discharge slots 41a and the print target is excessively short or excessively long, there is a concern that a desired amount of ink may not be discharged to a desired site.

On the other hand, in the optical type position detection sensor 18, a distance between a lens of the position detection sensor 18 and a print object is required to be set to at least “2.2 [mm]”. The reason for this is as follows. When the lens and the print object approach each other within the distance or shorter, it is difficult to receive reflected light and thus it is difficult to detect an accurate position. Therefore, even in disposition in which at least a part of the sensor projection region 18A is located within the cartridge projection region 40A to decrease a footprint size (occupation area) of the HMP 1, the discharge slots 41a are made to be close to the print object. In contrast, in the HMP 1 of this embodiment, the discharge slots 41a are provided in a portion that is not cut out when the ink cartridge 40 is viewed from a lateral side, and the position detection sensor 18 is provided at a cut-out portion.

Accordingly, it is possible to maintain the distance between the print object and the position detection sensor 18 to a distance capable of realizing appropriate detection while setting the distance between the discharge slots 41a and the print object to an appropriate distance. Since the distance between the discharge slots 41a and the print object is set to an appropriate distance, it is possible to discharge a desired amount of ink to a desired site. In addition, since the distance between the print object and the position detection sensor 18 is maintained to a distance capable of realizing appropriate detection, position detection accuracy of the position detection sensor 18 is improved. Due to the appropriate ink discharge and high-accuracy position detection, it is possible to improve an image quality of an image printed by the HMP 1 that is manually moved to form an image.

Positioning of the ink cartridge 40 with respect to the apparatus body in the front and back direction (Y-axis direction) is determined when the cartridge terminal 40b of the ink cartridge 40 pressed by the front and back spring 64 abuts against the FPC terminal 13 on the apparatus body side. That is, the cartridge terminal 40b also has a function as a “parallel direction positioning portion” that determines a position in the front and back direction. As illustrated in FIG. 13, the discharge slots 41a and the cartridge terminal 40b are disposed at a close position. According to this, it is possible to maintain a relative position relationship between the discharge slots 41a and the cartridge terminal 40b with high accuracy, and it is possible to perform positioning of the ink cartridge 40 with respect to the apparatus body in the front and back direction (the Y-axis direction).

In addition, a portion provided with high accuracy to be the front and back positioning portion also functions as a coupling portion between the cartridge terminal 40b and the FPC terminal 13, and thus it is possible to appropriately manage a contact pressure between the cartridge terminal 40b and the FPC terminal 13. According to this, since the contact pressure of a compression type terminal portion is appropriately managed, accuracy of the contact pressure in the terminal portion is improved, and it is possible to appropriately couple an electric portion of the apparatus body of the HMP 1 and an electric portion of the ink cartridge 40.

### MODIFICATION EXAMPLE 1

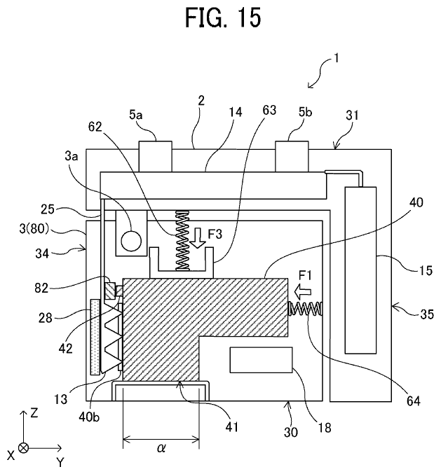

FIG. 15 is a schematic cross-sectional view of an HMP 1 of Modification Example 1 in which positioning in the front and back direction is performed at a site other than the terminal portion that performs electric connection when seen from a left lateral side. The HMP 1 of Modification Example 1 as illustrated in FIG. 15 includes a cartridge-side convex portion 42 that functions as a “parallel direction positioning portion” on an outer surface of the ink cartridge 40 on the rear surface 34 side, and includes a housing side convex portion 82 on an inner wall surface of a wall of the housing 80 on the rear surface 34 side. The HMP 1 of Modification Example 1 is different from the HMP 1 of the embodiment illustrated in FIG. 12 in that the cartridge-side convex portion 42 and the housing side convex portion 82 are provided.

In the HMP 1 of Modification Example 1, the cartridge-side convex portion 42 of the ink cartridge 40 pressed by the front and back spring 64 abuts against the housing side convex portion 82 of the apparatus body side, and thus a position of the ink cartridge 40 with respect to the apparatus body in the front and back direction is determined. That is, the cartridge-side convex portion 42 is a “parallel direction positioning portion” that is disposed in the vicinity of a unit terminal portion in the accommodation unit. In the HMP 1 of Modification Example 1, the cartridge-side convex portion 42 is provided in the vicinity of the cartridge terminal 40b, and the housing side convex portion 82 is provided in the vicinity of the FPC terminal 13. In this manner, the cartridge terminal 40b that is a compression type terminal portion is located in the vicinity of the positioning portion in the front and back direction (sub-scanning direction, the Y-axis direction) of the ink cartridge 40, and thus it is possible to appropriately manage the contact pressure of the cartridge terminal 40b with respect to the FPC terminal 13. Since the contact pressure of the compression type terminal portion is appropriately managed, and thus accuracy of the contact pressure in the terminal portion is improved, and it is possible to appropriately couple the electric portion of the apparatus body of the HMP 1 and the electric portion of the ink cartridge 40.

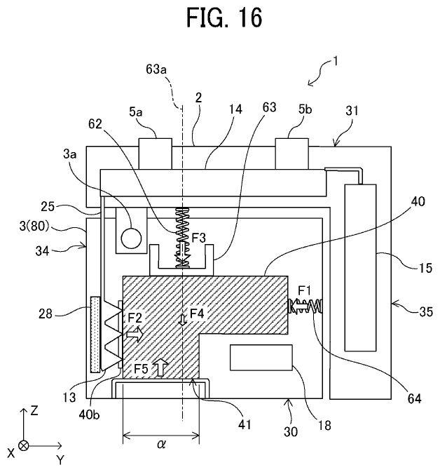

FIG. 16 is a schematic cross-sectional view illustrating forces acting on the ink cartridge 40 of the HMP 1 of the embodiment as illustrated in FIG. 12, and is a schematic cross-sectional view when seen from the left lateral surface 32 side (left side) that is an apparatus lateral surface orthogonal to the recording surface 30. “F1” in FIG. 16 represents a force that is applied by the front and back spring 64, “F2” represents a force that is applied to the FPC terminal 13 as a reaction force against “F1”. “F3” in FIG. 16 represents a force that is applied by the upper and lower spring 62, “F4” represents the weight of the ink cartridge 40, “F5” represents a force that is applied to the upper and lower direction positioning portion 65 from the opening edge inner wall surface 85 as a reaction force against “F3” and “F4”. A range indicated by “a” in FIG. 12 and FIG. 16 represents a range in which the upper and lower direction positioning portion 65 is located in the front and back direction (the Y-axis direction).

“F1” to “F5” in FIG. 16 satisfy the following Expressions (1) and (2).

F2+F2=0 (1)

F3+F4+F5=0 (2)

At this time, a site at which “F1” in FIG. 16 increases, that is, a contact site at which the pressure plate 63 biased by the upper and lower spring 62 locked to the upper unit 2 comes into contact with an upper surface of the ink cartridge 40 is located on an upward side of the upper and lower direction positioning portion 65. That is, as illustrated in FIG. 16, in the front and back direction (the Y-axis direction), a range in which a contact site of the pressure plate 63 with respect to the ink cartridge 40 is located, and a range in which the upper and lower direction positioning portion 65 is located (range indicated by “α”) at least partially overlap each other. When a position relationship between the pressure plate 63 and the upper and lower direction positioning portion 65 is set in this manner, a balance between forces acting on the ink cartridge 40 (relationships in Expressions (1) and (2)), and a balance between moments acting on the ink cartridge 40 are easily attained.

Even when the forces acting on the ink cartridge 40 satisfy the relationships in Expressions (1) and (2) and the balance is attained, in a case where a contact site of the pressure plate 63 and the upper and lower direction positioning portion 65 deviate from each other in the front and back direction, a rotation moment acts on the ink cartridge 40. In this case, sites on which “F1” and “F2” act in FIG. 16 and contribute to positioning in the front and back direction of the ink cartridge 40 are required to be disposed to cancel the rotational moment that occurs due to a force in the upper and lower direction, and it is difficult to attain a balance between moments. In contrast, in the HMP 1 of this embodiment, as illustrated in FIG. 12 and FIG. 16, a contact site of the pressure plate 63 in the front and back direction (the Y-axis direction) and the range in which the upper and lower direction positioning portion 65 is located (range indicated by “α”) at least partially overlap each other. According to this, the rotational moment acting on the ink cartridge 40 due to a force in the upper and lower direction is less likely to be generated, and thus it is easy to attain a balance between moments.

In the HMP 1, as illustrated in FIG. 16, in the front and back direction (the Y-axis direction), the central portion (“63a” in FIG. 16) in the range in which the contact site of the pressure plate 63 is located overlaps the range in which the upper and lower direction positioning portion 65 is located (the range indicated by “α” in FIG. 16). According to this, the rotational moment acting on the ink cartridge 40 due to a force in the upper and lower direction is less likely to be generated, and thus it is easy to attain a balance between moments.

In the HMP 1 of this embodiment, as illustrated in FIG. 16, in the front and back direction (the Y-axis direction), the contact site of the pressure plate 63 and the upper and lower direction positioning portion 65 are disposed to at least partially overlap each other. According to this, a pressing force of the upper and lower spring 62 through the pressure plate 63 (a pressing force of “F3” in FIG. 16) is enlarged, and thus it is possible to implement a configuration in which a balance of forces and moments which act on the ink cartridge 40 is attained.

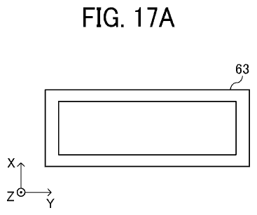

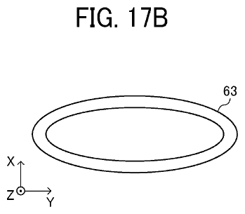

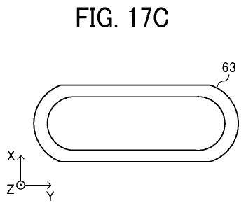

As a shape of a contact portion in which the pressure plate 63 contacts the upper surface of the ink cartridge 40, it is preferable that a planar shape viewed from the Z-axis direction is a shape such as a rectangular and an ellipse which have a long side and a short side, which is shorter than the long side, instead of a cubic shape or a circular shape. In addition, it is preferable that a longitudinal direction of the contact portion matches a longitudinal direction of the ink cartridge 40. FIGS. 17A to 17C are top views of three examples of the pressure plate 63. FIG. 17A is a view illustrating a pressure plate 63 of which a planar shape is a rectangle, FIG. 17B is a view illustrating a pressure plate 63 of which the planar shape is an ellipse, and FIG. 17C is a view illustrating a pressure plate 63 of which the planar shape is an oval shape.

In the disposition in which the longitudinal direction of the contact portion of the pressure plate 63 having the long side and the short side in the planar shape with respect to the ink cartridge 40 matches the longitudinal direction of the ink cartridge 40, it is possible to suppress the rotational moment from acting on the ink cartridge 40. According to this, it is possible to further stabilize the position of the ink cartridge 40 with respect to the main body of the HMP 1.

### MODIFICATION EXAMPLE 2

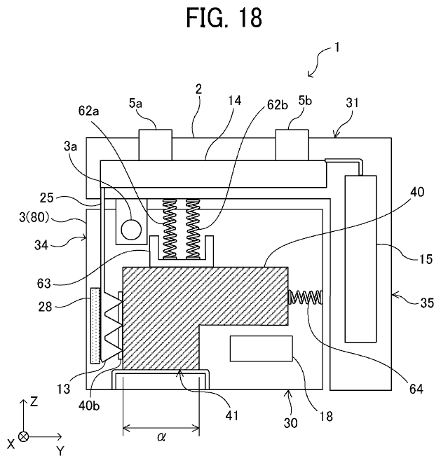

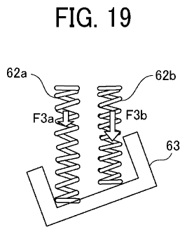

FIG. 18 is a schematic cross-sectional view of an HMP 1 of Modification Example 2 in which the upper and lower spring 62 includes two springs (a first upper and lower spring 62a and a second upper and lower spring 62b) having the same spring co-efficient when viewed from a left lateral side. The HMP 1 of Modification Example 2 illustrated in FIG. 18 is different from the HMP 1 of the embodiment illustrated in FIG. 12 in that two pieces of the upper and lower springs 62 are provided. FIG. 19 is a view illustrating a state in which the pressure plate 63 biased by the upper and lower springs 62 is inclined in the HMP 1 of Modification Example 2.

As in Modification Example 2, in a case where the plurality of upper and lower springs 62 is disposed, when the pressure plate 63 is inclined with respect to an apparatus body, a restoring force acts on the pressure plate 63 to be parallel to the recording surface 30. According to this, it is possible to maintain a state in which the pressure plate 63 is parallel to the recording surface 30, and thus it is possible to stably hold the ink cartridge 40.

A process in which the restoring force acts on the pressure plate 63 is as follows (items 1 to 4).

1. The ink cartridge 40 is inclined with respect to the apparatus body (housing 80) of the HMP 1 due to an operation by a user or an external force such as impact applied to the HMP 1.

2. The pressure plate 63 is inclined in conformity to the inclination of the ink cartridge 40.

3. A pressing force (“F3a” and “F3b” in FIG. 19) by the two upper and lower springs 62 (62a and 62b) fluctuates in correspondence with the inclination of the pressure plate 63.

4. In the state illustrated in FIG. 19, the second upper and lower spring 62b is further compressed in comparison to the first upper and lower spring 62a, and thus a pressing force is larger on the second upper and lower spring 62b side. Accordingly, a relationship of “F3a<F3b” is established, and a moment (recovering force) that rotates in a clockwise direction in FIG. 19 acts on the pressure plate 63.

As in the HMP 1 of Modification Example 2, the vertical direction biasing device includes the first upper and lower spring 62a and the second upper and lower spring 62b as a plurality of biasing members. According to this, even when the ink cartridge 40 is inclined with respect to the apparatus body, and the pressure plate 63 is inclined, the restoring force acts on the pressure plate 63, and a restoring force also acts on the ink cartridge 40 pressed to the pressure plate 63 in a direction in which an inclination disappears. Due to the restoring force, it is possible to improve stability of a mounting position of the ink cartridge 40 with respect to the apparatus body of the HMP 1.

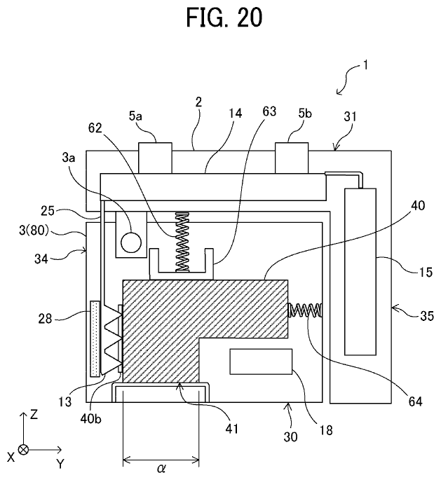

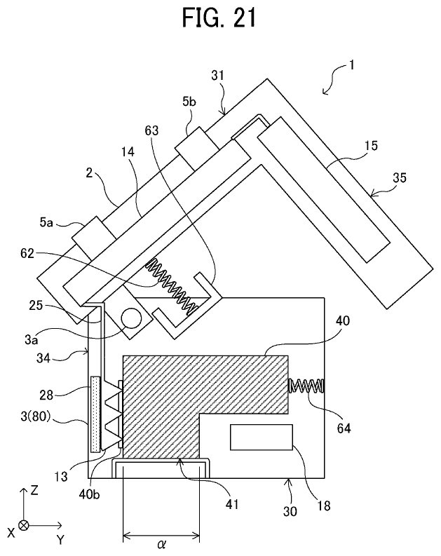

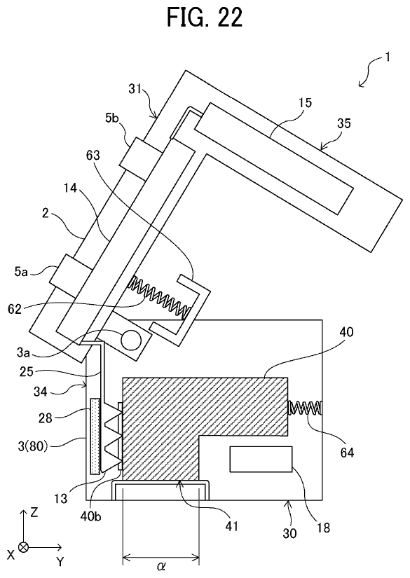

FIG. 20 to FIG. 22 are views illustrating an operation in which the upper unit 2 as a cover member that opens or closes the upper surface of the lower unit 3 rotates around the center of the upper-unit rotation shaft 3a to open or close the upper surface. FIG. 20 is a schematic cross-sectional view of the HMP 1 in a state in which the upper unit 2 is closed, FIG. 21 is a schematic cross-sectional view of the HMP 1 while the upper unit 2 is being released, and FIG. 22 is a schematic cross-sectional view of the HMP 1 in a state in which the upper unit 2 is opened.

In the HMP 1 of this embodiment, as illustrated in FIG. 12 and FIG. 16, the upper and lower spring 62 that is a vertical direction biasing device causing the force of “F3” to act, and the pressure plate 63 are disposed in the vicinity of the upper-unit rotation shaft 3a in the upper unit 2 that is a rotary member. According to this, it is possible to make a force required for an opening and closing operation of the upper unit 2 small, and it is possible to improve operability of a user who opens or closes the upper unit 2.

Even when a pressing force of the upper and lower spring 62 is the same as in each case, in a case where the upper and lower spring 62 and the pressure plate 63 are spaced away from the upper-unit rotation shaft 3a, a rotational moment of rotating the upper unit 2 to be released increases due to the biasing force of the upper and lower spring 62. When the rotation moment increases, a force required for an operation of causing the upper unit 2 in the opened state to enter the closed state increases. In addition, even in the closed state, it is required to increase a force for securing the upper unit 2 by the upper-unit lock claw 11 to maintain the closed state of the upper unit 2 that is in a state in which a large rotational moment acts. In addition, a large force is required for an operation of releasing the securing of the upper-unit lock claw 11 with a large securing force, and thus a large force is also required for an operation of causing the upper unit 2 in the closed state to enter the opened state.

On the other hand, in the HMP 1 of this embodiment, since the upper and lower spring 62 and the pressure plate 63 are disposed in the vicinity of the upper-unit rotation shaft 3a, it is possible to make the force required for the opening or closing operation of the upper unit 2 small, and thus it is possible to improve operability of a user who opens or closes the upper unit 2.

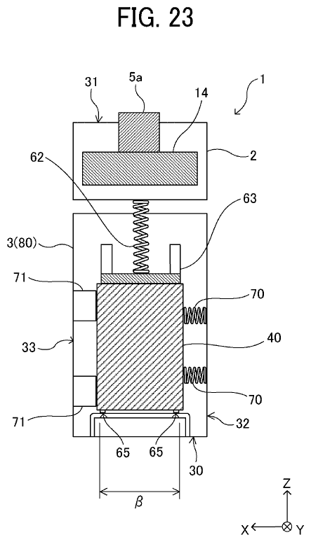

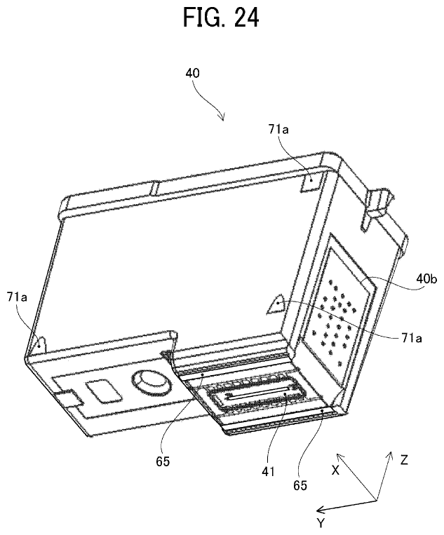

Next, description will be given of positioning of the ink cartridge 40 in the width direction (the manual scanning direction, the X-axis direction) with respect to the apparatus body of the HMP 1 of this embodiment. FIG. 23 is a schematic cross-sectional view of the HMP 1 taken through E-E of FIG. 12. FIG. 24 is an external perspective view of the ink cartridge 40 when seen from an obliquely downward side. As illustrated in FIG. 24, a cartridge-side width direction abutting portion 71a is provided at three sites on the right lateral surface of the ink cartridge 40.

As illustrated in FIG. 23, a width direction pressing spring 70 is provided on an inner wall surface of a wall of the housing 80 of the lower unit 3 on the left lateral surface 32 side, and a housing-side width direction abutting portion 71 is provided on an inner wall surface of a wall of the housing 80 on the right lateral surface 33 side. When the ink cartridge 40 is pressed by the width direction pressing spring 70 to the right lateral surface 33 side in the width direction, the cartridge-side width direction abutting portion 71a of the ink cartridge 40 is pressed to the housing-side width direction abutting portion 71 and is positioned.

As illustrated in FIG. 23, two pieces of the width direction pressing springs 70 are disposed to be aligned in the upper and lower direction, but one piece of the width direction pressing spring 70 may be disposed at a position that faces the vicinity of the center of the ink cartridge 40 in the upper and lower direction. In addition, the plurality of width direction pressing springs 70 may be disposed to be aligned in the front and back direction of the ink cartridge 40 (a direction orthogonal to a paper surface in FIG. 23). A range indicated by “β” in FIG. 23 represents a range interposed between the upper and lower direction positioning portions 65 in the width direction. In the width direction, when the upper and lower spring 62 is disposed within the range indicated by “β”, it is possible to prevent a rotational moment from acting due to the biasing force of the upper and lower spring 62, and thus it is possible to prevent the ink cartridge 40 from being inclined.

As illustrated in FIG. 12, a distance from an end of the HMP 1 on the rear surface 34 side to the central position of the recording section 41 in the front and back direction is set as “X1”, and a distance from the central position of the recording section 41 to a detection position of the position detection sensor 18 is set as “X2”. In addition, when a distance from the end of the HMP 1 on the rear surface 34 side to the detection position of the position detection sensor 18 is set as “X0”, a relationship of “X1=X1+X2” is established.

The distance “X0” is secured because the position detection sensor 18 is mounted on the housing 80 of the HMP 1, but distance “X1” slightly fluctuates due to a component and a mounting error for each device of the HMP 1, or an error at the time of mounting the ink cartridge 40. However, when the ink cartridge 40 is mounted on the apparatus body once, the ink cartridge 40 is pressed by the front and back spring 64 and is positioned, and thus it is possible to prevent the distance “X1” from fluctuating after mounting. The distance “X0” is secured, and the fluctuation of the distance “X1” after mounting can be prevented, and thus it is also possible to prevent the distance “X2” from fluctuating after mounting. According to this, it is possible to prevent a distance between an ink discharge position by the recording section 41 and the detection position by the position detection sensor 18 from fluctuating at the time of forming an image, and thus it is possible to perform stable image formation.

In addition, in the HMP 1 of this embodiment, with regard to positioning of the ink cartridge 40 with respect to the apparatus body, positioning in the upper and lower direction (the Z-axis direction) is performed by the upper and lower spring 62, and positioning in the width direction (the Y-axis direction) is performed by the width direction pressing spring 70. In this manner, the ink cartridge 40 after being mounted is positioned with respect to the apparatus body in any direction of three axes. Accordingly, a relative position between the ink discharge position by the recording section 41 and the detection position by the position detection sensor 18 is prevented from fluctuating at the time of forming an image, and thus it is possible to perform stable image formation.

In the above-described embodiment, the sensor projection region 18A is located on an inner side of the cartridge projection region 40A in the width direction (the X-axis direction), but a part of the sensor projection region 18A is located on an outer side of the cartridge projection region 40A in the front and back direction (the Y-axis direction). As a position relationship between the position detection sensor 18 and the ink cartridge 40, it is preferable that the sensor projection region 18A is disposed to be located inside the cartridge projection region 40A also in the front and back direction (Y-axis direction).

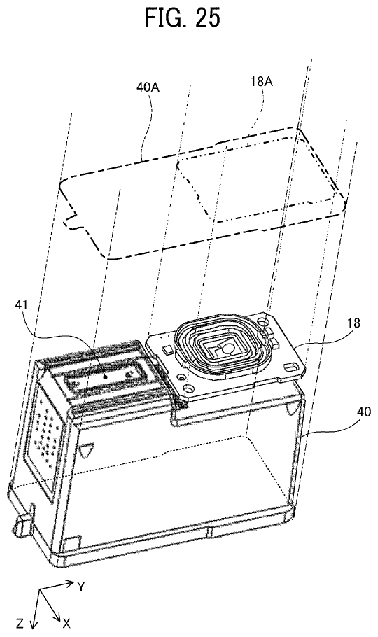

FIG. 25 is a view illustrating a configuration in which the entirety of the sensor projection region 18A is disposed to be located inside the cartridge projection region 40A. In the disposition as illustrated in FIG. 25, it is possible to make the size of the HMP 1 smaller in a direction parallel to the X-Y plane, and it is possible to make the occupation area of the HMP 1 smaller.

In the above-described embodiment, the position detection sensor 18 as one sensor has a function of a position detection device that detects a position of the apparatus, and a recording material detection device that detects presence or absence of the recording paper P. However, the invention is applicable to a configuration in which the position detection device and the recording material detection device are separately provided, or a configuration in which any one of the position detection device and the recording material detection device is provided.

In the above-described embodiment, description has been given of an example in which the invention is applied to the inkjet type HMP 1, but the configuration of the invention is also applicable to an apparatus realized by another image forming method. For example, the invention is applicable to a recording apparatus of an appropriate type such as a thermal type and a thermal transfer type.

The above-described configurations are illustrative only, and a specific effect is obtained for each aspect to be described below.

### Aspect 1

According to an aspect of the invention, there is provided a portable image forming apparatus such as the HMP 1 including: a recording section such as the recording section 41 which records an image on a recording material such as recording paper P; at least one (the position detection sensor 18 or the like) of a position detection device which detects a position of the portable image forming apparatus and a recording material detection device which detects presence or absence of the recording material; and an accommodation unit such as the ink cartridge 40 including an image formation material accommodation portion such as the ink tank. A projection region of the at least one of the position detection device and the recording material detection device with respect to a virtual plane parallel to a recording surface such as the recording surface 30 to face the recording material at least partially overlaps with a projection region of the accommodation unit with respect to the virtual plane. According to this, it is possible to make the size of the portable image forming apparatus in a direction along the recording surface small, and it is possible to make an installation space of the portable image forming apparatus small.

### Aspect 2

In the portable image forming apparatus according to Aspect 1, a range in which the position detection device or the recording material detection device is located in at least one direction (the X-axis direction, the width direction, or the like) parallel to the recording surface is inside a range in which the accommodation unit is located in the one direction. According to this, it is possible to set the size of the portable image forming apparatus in the one direction to a certain extent that is slightly larger than a size of the accommodation unit in the at least one direction.

### Aspect 3

In the portable image forming apparatus according to Aspect 1 or Aspect 2, the projection region of the at least one of the position detection device and the recording material detection device with respect to the virtual plane is located inside the projection region of the accommodation unit with respect to the virtual plane. According to this, as in the configuration illustrated in FIG. 25 described above, it is possible to make the size of the portable image forming apparatus in a direction along the recording surface smaller, and it is possible to make the installation space of the portable image forming apparatus smaller.

### Aspect 4

In the portable image forming apparatus according to any one of Aspect 1 to Aspect 3, the accommodation unit includes the recording section. According to this, as the accommodation unit in which the recording section and the image formation material accommodation portion are integrally formed, a configuration capable of being attached and detached to and from the apparatus body is implemented.

### Aspect 5

In the portable image forming apparatus according to Aspect 4, a parallel direction positioning portion such as the cartridge terminal 40b and the cartridge-side convex portion 42 which determines a position of the accommodation unit with respect to an apparatus body such as the housing 80 in a direction (the front and back direction, the Y-axis direction) parallel to the recording surface is provided in the vicinity of the recording section in the accommodation unit. According to this, it is possible to improve accuracy of a position of the recording section with respect to the apparatus body.

### Aspect 6

In the portable image forming apparatus according to any one of Aspect 1 to Aspect 5, the accommodation unit includes a parallel portion and a vertical portion that form an L-shaped. The parallel portion extends in a direction (the front and back direction, the Y-axis direction) parallel to the recording surface and the vertical portion extends in a direction (the upper and lower direction, the Z-axis direction) orthogonal to the recording surface. According to this, it is possible to implement a configuration using an accommodation unit including the vertical portion projecting in a direction orthogonal to the recording surface with respect to the parallel portion.

### Aspect 7

In the portable image forming apparatus according to Aspect 6, at least a part of the at least one of the position detection device and the recording material detection device is disposed in a space surrounded by the L-shape of the accommodation unit from two directions such as the upper surface 31 side and the rear surface 34 side. According to this, it is possible to dispose at least a part of at least one of the position detection device and the recording material detection device in a dead space formed between a housing of the apparatus body such as the housing 80 and the accommodation unit, and thus it is possible to realize a reduction in size of the apparatus.

### Aspect 8

In the portable image forming apparatus according to Aspect 6 or Aspect 7, the vertical portion further projects toward the recording surface (the downward side) than the parallel portion, and a vertical direction positioning portion such as the upper and lower direction positioning portion 65 which determines a position of the accommodation unit with respect to the apparatus body in a direction (the upper and lower direction) orthogonal to the recording surface. The vertical direction positioning portion and the recording section are provided in an end (lower end) of the vertical portion facing the recording surface. According to this, a distance from the recording section to the recording material can be set to an appropriately distance, and it is possible to improve image quality. In addition, since the recording section is disposed in the projecting portion of the L-shape, it is possible to realize a reduction in size of the entirety of the apparatus.

### Aspect 9

In the portable image forming apparatus according to any one of Aspect 1 to Aspect 8, the accommodation unit includes a unit terminal portion such as the cartridge terminal 40b that is electrically coupled to an apparatus body, and a parallel direction positioning portion such as the cartridge-side convex portion 42 which determines a position of the accommodation unit with respect to the apparatus body in a direction (the front and back direction, the Y-axis direction) parallel to the recording surface is provided in the vicinity of the unit terminal portion in the accommodation unit. According to this, accuracy of a contact pressure in the unit terminal portion is improved, and it is possible to appropriately couple an electric portion of the accommodation unit and an electric portion of the apparatus body.

### Aspect 10

In the portable image forming apparatus according to any one of Aspect 1 to Aspect 8, the accommodation unit includes a unit terminal portion such as the cartridge terminal 40b that is electrically coupled to an apparatus body, and a parallel direction positioning portion which determines a position of the accommodation unit with respect to the apparatus body in a direction (the front and back direction, the Y-axis direction, or the like) parallel to the recording surface is the unit terminal portion such as the cartridge terminal 40b. According to this, a portion provided with high accuracy to be the parallel direction positioning portion also functions as a connection portion between the unit terminal portion and a main body side terminal portion such as the FPC terminal 13, and thus it is possible to appropriately manage a contact pressure between the unit terminal portion and the main body terminal portion. According to this, accuracy of a contact pressure in the unit terminal portion is improved, and it is possible to appropriately couple the electric portion of the accommodation unit and the electric portion of the apparatus body.

### Aspect 11

The portable image forming apparatus according to any one of Aspect 1 to Aspect 10 further includes a horizontal direction biasing device such as the front and back spring 64 which biases a surface opposite to a surface, on which a parallel direction positioning portion such as the cartridge terminal 40b and the cartridge-side convex portion 42 which determines a position of the accommodation unit with respect to an apparatus body in a direction (the front and back direction, the Y-axis direction) parallel to the recording surface on a surface of the accommodation unit is provided, toward the parallel direction positioning portion. According to this, it is possible to perform positioning of the accommodation unit with respect to the apparatus body in a direction parallel to the recording surface. In addition, in particular, in an aspect according to Aspect 8 or Aspect 9, accuracy of a contact pressure in the unit terminal portion is improved, and it is possible to appropriately couple the electric portion of the accommodation unit and the electric portion of the apparatus body.

### Aspect 12

The portable image forming apparatus according to any one of Aspect 1 to Aspect 11 further includes a vertical direction biasing device such as the upper and lower spring 62 which biases a surface (the upper surface or the like) opposite to a surface (the lower surface or the like), on which a vertical direction positioning portion such as the upper and lower direction positioning portion 65 which determines a position of the accommodation unit with respect to an apparatus body in a direction orthogonal to the recording surface on a surface of the accommodation unit is provided, toward the vertical direction positioning portion. According to this, it is possible to perform positioning of the accommodation unit with respect to the apparatus body in a direction orthogonal to the recording surface.

### Aspect 13

In the portable image forming apparatus according to Aspect 12, a range in which a vertical biasing contact portion such as the lower surface of the pressure plate 63, at which the vertical direction biasing device contacts the accommodation unit, is located in a direction parallel to the recording surface, and a range in which the vertical direction positioning portion is located at least partially overlap each other when seen from an apparatus lateral surface side (a left side or the like) orthogonal to the recording surface. According to this, it is possible to easily attain a balance of forces acting on the accommodation unit, and a balance of moments acting on the accommodation unit.

### Aspect 14

In the portable image forming apparatus according to Aspect 13, a central portion (“63a” or the like in FIG. 16) of a range in which the vertical biasing contact portion is located in a direction parallel to the recording surface overlaps a range in which the vertical direction positioning portion is located in the direction parallel to the recording surface, when seen from the apparatus lateral surface side orthogonal to the recording surface. According to this, it is possible to more easily attain a balance of forces acting on the accommodation unit, and a balance of moments acting on the accommodation unit.

### Aspect 15

In the portable image forming apparatus according to Aspect 13 or Aspect 14, the vertical biasing contact portion has a shape in which a planar shape seen from a direction orthogonal to the recording surface has a long side and a short side shorter than the long side. According to this, it is possible to further stabilize a position of the accommodation unit with respect to the apparatus body.

### Aspect 16

In the portable image forming apparatus according to any one of Aspect 12 to Aspect 15, the vertical direction biasing device includes a plurality of biasing members such as the first upper and lower spring 62a and the second upper and lower spring 62b. According to this, it is possible to allow a restoring force to act when the accommodation unit is inclined with respect to the apparatus body, and it is possible to improve stability of a mounting position of the accommodation unit with respect to the apparatus body.

### Aspect 17

The portable image forming apparatus according to any one of Aspect 12 to Aspect 16 further includes a rotary member such as the upper unit 2 held on an apparatus body to freely rotate around a rotation shaft such as the upper-unit rotation shaft 3a, and the vertical direction biasing device is disposed in the vicinity of the rotation shaft in the rotary member. According to this, it is possible to improve operability in an operation of rotating the rotary member.

### Aspect 18

The portable image forming apparatus according to any one of Aspect 1 to Aspect 17 further includes a recording material detector having a function of the position detection device and a function of the recording material detection device. According to this, it is possible to reduce the number of parts, and it is possible to realize a reduction in size of the portable image forming apparatus.

### Aspect 19

In the portable image forming apparatus according to Aspect 18, the recording material detector is a reflection type sensor. According to this, since the reflection type sensor that is typically used is used, it is possible to realize a reduction in size and the cost of the apparatus.

### Aspect 20

In the portable image forming apparatus according to Aspect 18 or Aspect 19, the recording material detector is an optical type sensor. According to this, since the optical type sensor that is typically used is used, it is possible to realize a reduction in size and the cost of the apparatus.

### Aspect 21

According to another aspect of the invention, there is provided a portable image forming apparatus body such as the apparatus body of the HMP 1 includes at least one (the position detection sensor 18 or the like) of a position detection device which detects a position of the apparatus and a recording material detection device which detects presence or absence of a recording material. An accommodation unit such as the ink cartridge 40 includes a recording section such as the recording section 41 which records an image and an image formation material accommodation portion such as the ink tank is attached to and detached from the image forming apparatus body. A projection region of the at least one of the position detection device and the recording material detection device with respect to a virtual plane parallel to a recording surface such as the recording surface 30 to face the recording material such as the recording paper P at least partially overlaps with a projection region of the accommodation unit attached to the portable image forming apparatus body with respect to the virtual plane. According to this, as in Aspect 1, it is possible to make the size of the portable image forming apparatus in a direction along the recording surface small, and it is possible to make an installation space of the portable image forming apparatus small.

This patent application is based on and claims priority pursuant to 35 U.S.C. § 119(a) to Japanese Patent Application No. 2018-185169, filed on Sep. 28, 2018, in the Japan Patent Office, the entire disclosure of which is hereby incorporated by reference herein.

### REFERENCE SIGNS LIST

1 HMP

2 Upper Unit

2b Vertical Extending Portion

2a Horizontal Extending Portion

3 Lower Unit

3a Upper-Unit Rotation Shaft

5a Print Key

5b Power Key

7 Sub-Scanning Guide

9 Connection Port

10 Main Scanning Guide

11 Upper-Unit Lock Claw

12 Cartridge Attachment and Detachment Mechanism

12a Attachment and Detachment Operating Portion

13 FPC Terminal

14 Control Board

15 Battery

18 Position Detection Sensor

18A Sensor Projection Region

19 Temperature Sensor

21 Cartridge Pressing Member

25 Flexible Flat Cable

28 Elastic Member

30 Recording Surface

30a Discharge Opening

31 Upper Surface

32 Left Lateral Surface

33 Right Lateral Surface

34 Rear Surface

35 Front Surface

37a First Left Roller

37b Second Left Roller

37c Left Rotation Shaft

38a First Right Roller

38b Second Right Roller

38c Right Rotation Shaft

39 Grip Portion

40 Ink Cartridge

40A Cartridge Projection Region

40b Cartridge Terminal

41 Recording Section

41a Discharge Slot

42 Cartridge-Side Convex Portion

52 Bt Board

56 Recording Controller

58 Gyro Sensor

59 LED Lamp

62 Upper and Lower Spring

62a First Upper and Lower Spring

62b Second Upper and Lower Spring

63 Pressure Plate

64 Front and Back Spring

65 Upper and Lower Direction Positioning Portion

70 Width Direction Pressing Spring

71 Housing-Side Width Direction Abutting Portion

71a Cartridge-Side Width Direction Abutting Portion

80 Housing

82 Housing-Side Convex Portion

85 Opening Edge Inner Wall Surface

302 Detection Opening

H Hand

P Recording Paper

W1 Print Portion

W2 Print Scheduled Portion

1. A portable image forming apparatus comprising:
a recording section configured to record an image on a recording material;
at least one of a position detection device configured to detect a position of the portable image forming apparatus and a recording material detection device configured to detect presence or absence of the recording material; and
an accommodation unit including an image formation material accommodation portion,
wherein a projection region of the at least one of the position detection device and the recording material detection device with respect to a virtual plane parallel to a recording surface to face the recording material at least partially overlaps with a projection region of the accommodation unit with respect to the virtual plane.

2. The portable image forming apparatus according to claim 1,
wherein a range in which the position detection device or the recording material detection device is located in at least one direction parallel to the recording surface is inside a range in which the accommodation unit is located in the at least one direction.

3. The portable image forming apparatus according to claim 1,
wherein the projection region of the at least one of the position detection device and the recording material detection device with respect to the virtual plane is inside the projection region of the accommodation unit with respect to the virtual plane.

4. (canceled)

5. The portable image forming apparatus according to claim 4, further comprising a parallel direction positioning portion disposed in vicinity of the recording section in the accommodation unit and configured to determine a position of the accommodation unit with respect to an apparatus body in a direction parallel to the recording surface.

6. The portable image forming apparatus according claim 1,
wherein the accommodation unit includes a parallel portion and a vertical portion that form an L-shape, the parallel portion extending in a direction parallel to the recording surface, the vertical portion extending in a direction orthogonal to the recording surface.

7. The portable image forming apparatus according to claim 6,
at least a part of the at least one of the position detection device and the recording material detection device is disposed in a space surrounded by the L-shape of the accommodation unit from two directions.

8. The portable image forming apparatus according to claim 6, further comprising a vertical direction positioning portion configured to determine a position of the accommodation unit with respect to the apparatus body in a direction orthogonal to the recording surface,
wherein the vertical portion further projects toward the recording surface than the parallel portion, wherein the vertical direction positioning portion and the recording section are provided in an end of the vertical portion facing the recording surface.

9. The portable image forming apparatus according to claim 1, further comprising a parallel direction positioning portion configured to determine a position of the accommodation unit with respect to the apparatus body in a direction parallel to the recording surface,
wherein the accommodation unit includes a unit terminal portion that is electrically coupled to an apparatus body,
wherein the parallel direction positioning portion is provided in vicinity of the unit terminal portion in the accommodation unit.

10. The portable image forming apparatus according to claim 1,
wherein the accommodation unit includes a unit terminal portion that is electrically coupled to an apparatus body,
wherein the unit terminal portion is a parallel direction positioning portion configured to determine a position of the accommodation unit with respect to the apparatus body in a direction parallel to the recording surface is the unit terminal portion.

11. The portable image forming apparatus according to claim 1, further comprising:
a parallel direction positioning portion configured to determine a position of the accommodation unit with respect to an apparatus body in a direction parallel to the recording surface on a surface of the accommodation unit; and
a horizontal direction biasing device configured to bias a surface opposite to a surface on which the parallel direction positioning portion is provided, toward the parallel direction positioning portion.

12. The portable image forming apparatus according claim 1, further comprising:
a vertical direction positioning portion configured to determine a position of the accommodation unit with respect to an apparatus body in a direction orthogonal to the recording surface on a surface of the accommodation unit; and
a vertical direction biasing device configured to bias a surface opposite to a surface on which the vertical direction positioning portion is provided, toward the vertical direction positioning portion.

13. The portable image forming apparatus according to claim 12,
wherein a range in which a vertical biasing contact portion, at which the vertical direction biasing device contacts the accommodation unit, is located in a direction parallel to the recording surface at least partially overlaps a range in which the vertical direction positioning portion is located, when seen from an apparatus lateral surface orthogonal to the recording surface.

14. The portable image forming apparatus according to claim 13,
wherein a central portion of a range in which the vertical biasing contact portion is located in a direction parallel to the recording surface overlaps a range in which the vertical direction positioning portion is located in the direction parallel to the recording surface when seen from the apparatus lateral surface orthogonal to the recording surface.

15. The portable image forming apparatus according to claim 13,
wherein the vertical biasing contact portion has a shape in which a planar shape seen from the direction orthogonal to the recording surface has a long side and a short side shorter than the long side.

16. The portable image forming apparatus according to claim 12,
wherein the vertical direction biasing device includes a plurality of biasing members.

17. The portable image forming apparatus according to claim 12, further comprising:
a rotary member held on an apparatus body to freely rotate around a rotation shaft,
wherein the vertical direction biasing device is disposed in vicinity of the rotation shaft in the rotary member.

18. The portable image forming apparatus according to claim 1, further comprising a recording material detector having a function of the position detection device and a function of the recording material detection device.

19. The portable image forming apparatus according to claim 18,
wherein the recording material detector is a reflection type sensor.

20. The portable image forming apparatus according to claim 18,
wherein the recording material detector is an optical type sensor.

21. A portable image forming apparatus body comprising:
at least one of a position detection device configured to detect a position of the portable image forming apparatus body and a recording material detection device configured to detect presence or absence of a recording material;
an accommodation unit including:
a recording section configured to record an image on the recording material; and
an image formation material accommodation portion detachably attached with respect to the portable image forming apparatus body,
wherein a projection region of the at least one of the position detection device and the recording material detection device with respect to a virtual plane parallel to a recording surface to face the recording material at least partially overlaps with a projection region of the accommodation unit attached to the portable image forming apparatus body with respect to the virtual plane.
